(19) United States
(12) Patent Application Publication
(10) Pub. No.: US 2006/0182208 A1
(43) Pub. Date: Aug. 17, 2006

(54) STBC scheme using MMSE decision in a non quasi-static channel

(76) Inventors: In-Kyu Lee, Seoul (KR); Bong-Dae Choi, Seoul (KR); Chang-Kyung Sung, Seoul (KR); Wook-Bong Lee, Seongnam (KR)

Correspondence Address: MEREDITH & KEYHANI, PLLC, 330 MADISON AVE., 6TH FLOOR, NEW YORK, NY, 10017, US

(21) Appl. No.: 11/056,757

(22) Filed: Feb. 11, 2005

(51) Int. Cl. H04B 7/10; H04B 7/02

(52) U.S. Cl. 375/347; 375/267

(57) ABSTRACT

The present invention provide a space time block codes (STBC) scheme, where a received signal is filtered by using a minimum mean square error (MMSE) filter, and where channel symbols are individually decoded and converted into bit information, so that an mean square error (MSE) can be minimized by using a linear superposition form applicable to the non quasi-static channel environment as well as a quasi-static channel environment. The present invention provides an STBC scheme using a MMSE filter obtained in a real linear representation method, so that transmitted data can be recovered without loss thereof even in a case where a speed of a mobile station is high.

### BACKGROUND OF THE INVENTION

The present invention relates to space time block codes (STBC) scheme using a minimum mean square error (MMSE) filter and more particularly, to a STBC scheme capable of minimizing a mean square error (MSE) by using a linear superposition form applicable to the non quasi-static channel environment as well as a quasi-static channel environment.

As demands for high-speed data transmission in next generation wireless communication systems have increased, multiple antenna systems have been developed in order to increase capacity, throughput, and coverage of the wireless communication system. The multiple antenna systems are classified into a spatial division multiplexing (SDM) scheme and a space time coding (STC) scheme.

The SDM scheme can increase the throughput of the associated system. However, the SDM scheme is limited in that the number of receive antennas is larger than the transmit antennas. This results in increased costs of downlink mobile stations and an added complexity to the system. Because of this, the SDM scheme is not generally used.

The STC scheme can obtain diversity gains by using multiple transmit antennas in a fading channel environment, so that the STC scheme is suitable for a downlink mobile station, where a receive antenna diversity is hard to obtain.

In the STC scheme, a spatial diversity in a coding structure is used to improve link level. The STC scheme is classified into a space time trellis code (STTC) scheme and a space time block codes (STBC) scheme.

According to the STTC scheme, good encoding and diversity gains can be obtained by using multiple antennas. However, in order to obtain a maximum diversity order, a complexity of a maximum likelihood (ML) decoder exponentially increases with respect to the number of transmit antennas and the transmission rate. Therefore, it is difficult to implement the encoder and decoder in accordance with the STTC scheme.

In order to overcome the limitations of the STTC scheme, a STBC scheme has been proposed. In the STBC scheme, the number of receive antennas is not limited. In addition, the STBC Scheme can give a high performance even in case of low signal-to-noise ratio (SNR) due to the spatial diversity gain. Because of this, an STBC scheme is desirable.

FIGS. 1A and 1B depict a general STBC scheme. FIG. 1A is a block diagram showing a construction of a transmitter used for a conventional STBC scheme. FIG. 1B is block diagram showing a construction of a receiver for a signal transmitted from the transmitter of FIG. 1A.

Referring to FIG. 1A, the transmitter comprises a serial-to-parallel converter 20, mappers 30, a spacetime encoder 40 and n transmit antennas 50. The mappers 30 generate STBC channel symbols and input the symbols inputted to the space-time encoder 40.

The serial-to-parallel converter 20 converts serial symbols input by a predetermined information source 10 to parallel symbol blocks by grouping the K x m serial symbols in one block. The parallel channel symbol blocks are input to the mappers 30. Here, K denotes the number of symbols belonging to one block during an STBC time interval, and m denotes the number of bits per symbol.

The space time encoder 40 generate a predetermined number of combinations from the input K symbols, encodes the symbol combinations into STBC in accordance with the STBC scheme and outputs the STBC symbols to the n transmit antenna 50 during a corresponding code time period L.

Turning to FIG. 1B, the receive used for the conventional STBC scheme comprises m receive antennas 60, a space-time decoder 70, de-mappers 80, and a parallel-to-serial converter 90. The m receive antennas 60 receives the STBC symbols transmitted from the n transmit antennas 50. The STBC decoder 70 decodes the STBC symbols and outputs the decoded STBC symbols to the respective de-mappers 80. Each of the de-mappers 80 performs a mapping process of mapping the decoded STBC symbols into bit information. The parallel-to-serial converter 90 converts the bit information (parallel symbols) to original information symbols (serial symbols) 100.

According to the conventional STBC scheme with the code time period L, a received signal can be represented with STBC code matrix C by using the following equation:

$${r}_{m , 1} = {\sum }_{n = 1}^{N} {h}_{mn , 1} {c}_{1 , n} + {w}_{m , 1} \qquad [ Equation 1 ]$$

Here, r_{m,1} denotes a received signal of an m-th receive antenna during an 1-th time interval. h_{mn,1} denotes a propagation gain of a channel from an n-th transmit antenna to an m-th receive antenna during an 1-th time interval. m,n and 1 denote the number of receive antennas, the number of transmit antennas, and a time interval when a specific block is transmitted, respectively. In addition, c_{1,n} denotes a (1, m) component of the STBC code matrix C having L rows and N columns. W_{m,1} denotes an additive white complex Gaussian noise generated during the 1-th time interval. The noise w_{m,1} has an independent zero-mean complex Gaussian characteristic with a variation σ²ₙ for each dimension. In case of the aforementioned quasi-static channel environment, the time index 1 may be omitted.

On the other hand, in case of the quasi-static channel environment, by collecting the received signal in a vector form, Equation 1 can be written as Equation 2. In the flowing Equation 2, (·)^{T}, (·)*, and (·)^{H} denote a transpose matrix, a complex conjugate matrix, and a Hermitian transpose matrix, respectively.
R=CH^{T}+N [Equation 2]

In a case where the STBC code matrix C is an orthogonal matrix, the corresponding scheme is called an orthogonal STBC scheme. According to the orthogonal STBC scheme, a maximum likelihood decoding process can be performed as a simple linear process in a receiver. In other words, in the orthogonal STBC scheme, the encoding process can be preformed by using a simple autocorrelation apparatus, so that complexity of the system can be effectively reduced. In addition, according to the orthogonal STBC scheme, it is possible to obtain a full diversity.

However, the orthogonal STBC scheme has a problem in that a full rate cannot be obtained in a system using more than two antennas. In addition, in a next generation wireless communication system environment, a high carrier frequency and a high mobility for a mobile station are required. In this environment, the orthogonal STBC scheme, where a maximum likelihood encoder is implemented as an orthogonal linear encoder, increases a Doppler frequency. Therefore, the environment cannot be estimated as a quasi-static channel environment where the channel must not vary during a unit time interval. In other words, the environment may be not quasi-static but non quasi-static. Consequently, the orthogonal STBC scheme has a problem in that the received signal cannot be even represented by using the aforementioned Equation 2.

In the STBC scheme using the only two transmit antennas, Equation 2 can be represented by using a complex linear superposition form. In addition, Equation 2 can be corrected by using a minimum mean square error (MMSE) method, and then, the channel symbols can be individually decoded. On the contrary, in the orthogonal STBC scheme using more than two transmit antennas, Equation 2 cannot be represented by using a complex linear superposition form.

In addition, there is a maximum likelihood decoding scheme, where channel symbols belonging to all the block codes are simultaneously estimated. However, the maximum likelihood decoding scheme cannot be practically used due to high complexity thereof.

In general, in the quasi-static channel environment, if the code matrix C is an orthogonal matrix, the corresponding channel matrix H is also an orthogonal matrix. In this case, a transpose matrix of the real part of the channel matrix H corresponds to a matching filer (MF), it is possible to optimize individual channel symbols by using the matching filter. On the contrary, in the non quasi-static channel environment, even if the code matrix C is an orthogonal matrix, the corresponding channel matrix H is not an orthogonal matrix. In this case, it is impossible to implement an accurate matching filter (MF), so that a portion of symbols can be lost.

In addition, in a case where the code matrix is not an orthogonal matrix, although a maximum likelihood (ML) decoder is one of optimal encoders, the ML decoder has high order in codes and high complexity in array sizes, so that the ML decoder cannot be practically used.

The present invention attempts to overcome the problems in the prior art to provide a space time block code (STBC) scheme, so that a mean square error (MSE) can be minimized by using a linear superposition form applicable to both non quasi- and quasi-static channel environments.

### SUMMARY OF THE INVENTION

The present invention provides a space time block code (STBC) scheme in which a received signal is filtered by using a minimum mean square error (MMSE) filter and where channel symbols are individually decoded and converted into bit information, so that a mean square error (MSE) can be minimized by using a linear superposition form applicable to the non quasi-static and quasi-static channel environment.

In addition, another object of the present invention is to provide a linear equalizer to be applied to a MMSE filter by using a lattice representation method where a code matrix is decomposed into real and imaginary parts, so that it is possible to implement high performance STBC scheme used for a non quasi-static channel environment.

In addition, still another object of the present invention is to provide an STBC scheme using a MMSE filter obtained in a real linear representation method, so that transmitted data can be recovered without loss thereof even in a case where a speed of a mobile station is high.

In order to achieve the objects, the present invention provides a STBC scheme using a MMSE filter, where an STBC scheme can minimize a mean square error (MSE) by using a linear superposition form applicable to the non quasi-static channel environment as well as a quasi-static channel environment.

According to one aspect of the present invention, a non quasi-static space time block codes (STBC) method used for a wireless communication system is disclosed, where information symbols represented with code matrix C, channel matrix H and noise matrix N are coded in space time coding scheme and transmitted through a plurality of transmit antennas to a receive antenna, the method comprising the steps of; receiving one block of information symbols by a receive antenna to provide received information symbols; decomposing the code matrix C of received information symbols into real and imaginary parts; matching the code matrix C to the channel matrix H and obtaining a real channel response matrix corresponding to the channel matrix H matched to the code matrix C; and minimizing a Mean square error (MSE) of a received signal, wherein the received signal is obtained from the step of matching the code matrix C, by using a minimum mean square error (MMSE) filter and decoding each of channel symbols to be converted into bit information. Each of the real channel response matrixes may be represented by the following equation:

$$\tilde{H} = [ \begin{matrix}{H}_{1}^{R} & - {H}_{2}^{I} \\ {H}_{1}^{I} & {H}_{2}^{R}\end{matrix} ]$$

According to another aspect of the present invention, a receiver used for a non quasi-static space time block codes (STBC) system is disclosed using a minimum mean square error (MMSE) filter, the receiver comprising: m receive antennas for receiving space time block code symbols transmitted from n transmit antennas of a transmitter; a space time equalizer having the MMSE filter to decode symbols output from the m receive antennas; and at least one de-mapper for converting k symbols filtered by the MMSE filter into bit information.

This summary is not to be taken in a limiting sense, but is made merely for the purpose of illustrating the general principles of the invention, since the scope of the invention is best defined by the appended claims.

### BRIEF DESCRIPTION OF THE DRAWINGS

The above and other features and advantages of the present invention will become more apparent by describing in detail exemplary embodiments thereof with reference to the attached drawings in which:

FIG. 1A is a block diagram showing a construction of a transmitter used for a conventional STBC scheme;

FIG. 1B is a block diagram showing a construction of a receiver for a signal transmitted from the transmitter of FIG. 1A;

FIG. 2A is a block diagram showing a construction of a transmitter used for an STBC scheme using an MMSE filter in a non quasi-static channel environment according to the present invention;

FIG. 2B is a block diagram showing a construction of a receiver for a signal transmitted from the transmitter of FIG. 2A;

FIG. 3A is a graph showing a frame error rate (FER) of a matching filter (MF) used for a conventional STBC scheme; and

FIG. 3B is a graph showing an FER of the MMSE filter used for the STBC scheme according the present invention.

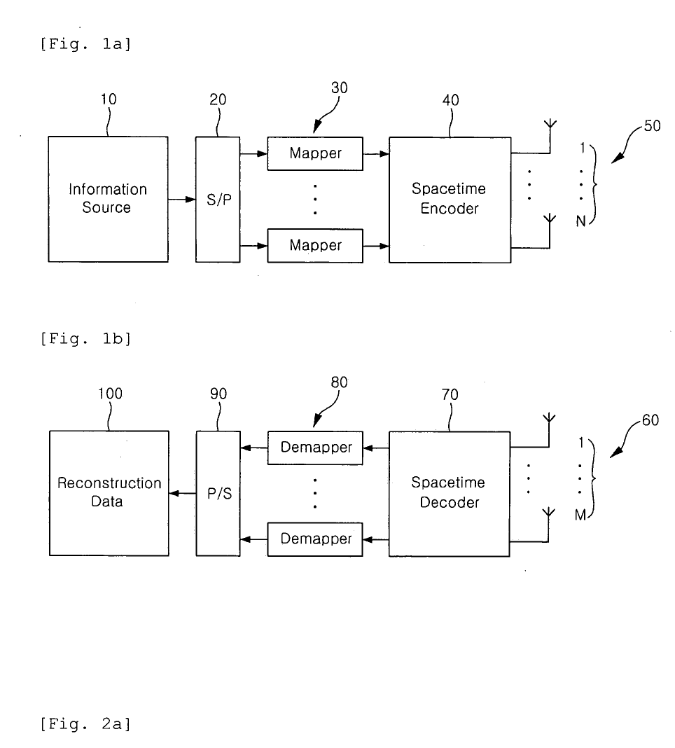

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims. Hereinafter, the present invention will be described in detail by explaining exemplary embodiments of the invention with reference to the attached drawings. Like reference numerals in the drawings denote like elements.

According to one aspect of the present invention, a non quasi-static space time block codes (STBC) method is used for a wireless communication system where information symbols represented with code matrix C, channel matrix H and noise matrix N are coded in space time coding scheme and transmitted through a plurality of transmit antennas to a receive antenna. The method comprising the steps of: receiving one block of information symbols by a receive antenna to provide received information symbols; decomposing the code matrix C of the received information symbols into real and imaginary parts; matching the code matrix C to the channel matrix H; obtaining a real channel response matrix corresponding to the channel matrix H matched to the code matrix C to provide a received signal having a real channel response matrix; minimizing a mean square error (MSE) of the received signal, by using a minimum mean square error (MMSE) filter; decoding channel symbols in the real channel response matrix; and converting the channel symbols into bit information.

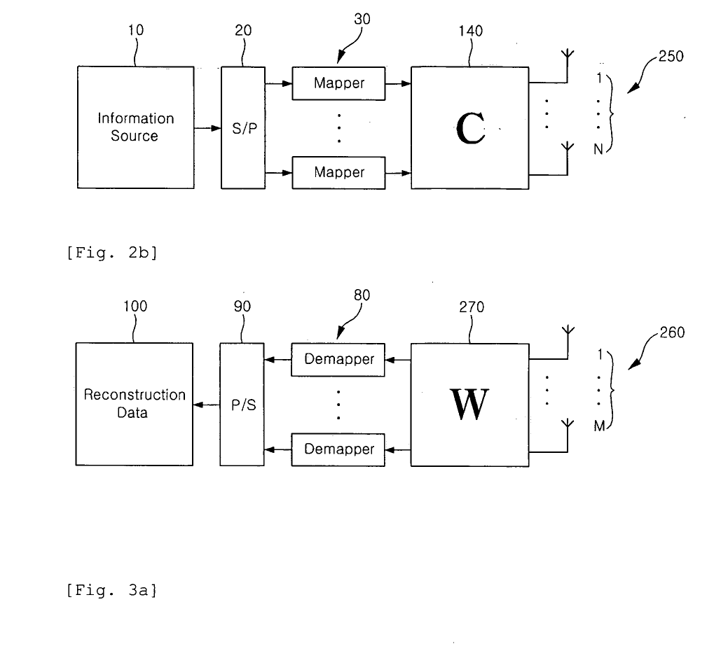

FIG. 2A is a block diagram showing a construction of STBC transmitter used for a space time block codes (STBC) scheme using an MMSE filter in a non quasi-static channel environment according to the present invention. FIG. 2B is a block diagram showing a construction of a STBC receiver for a signal transmitted from the transmitter of FIG. 2A.

Referring to FIG. 2A, the STBC transmitter has the same construction as that of a conventional STBC transmitter. The STBC transmitter comprises a parallel-to-serial converter 20, mappers 30, a space time encoder 140, and n transmit antennas 250.

Referring to FIG. 2B, the STBC receiver comprises m receive antennas 260, an MMSE filter 270, de-mappers 80, and a parallel-to-serial converter 90. Each of the de-mappers 80 converts received symbols into bit information and outputs the bit information to the parallel-to-serial converter 90.

In the embodiment of the present invention, the MMSE filter 270 serves as a space-time decoder. The MMSE filter 270 is implemented in a linear superposition form using a lattice representation method. Now, the linear superposition form will be described in detail.

The channel symbols in the STBC scheme can be represented by a code matrix C. The code matrix C is decomposed into real and imaginary parts as shown in the following Equation 3. Here, c denotes a real and imaginary parts of the code matrix C in the lattice representation method.
\tilde{C}=[C^{R}C^{I}] [Equation 3]

As described above, C^{R} and C^{I} denote the real and imaginary parts of the code matrix C or the vectors thereof, respectively. Channel symbols zₖ in the STBC scheme are represented by zₖ=xₖ+j*yₖ. The (I, n) components of the code matrix C can be represented by C_{l,n}=c₁*xₖ+j*c₂*yₖ, where c₁ and c₂ are scalar coefficients. The i-th row vector of the code matrix C has real and imaginary parts represented by the following Equation 4.
cᵢ^{R}=[ . . . c₁·xₖ . . . ], [Equation 4]
cᵢ^{I}=[ . . . c₂·yₖ . . . ]

In an example, there is a ¾-rate orthogonal STBC system having 4 transmit antennas. The code matrix C of the ¾-rate orthogonal STBC system can be represented by the following Equation 5.

$$C = [ \begin{matrix}{z}_{1} & {z}_{2} & {z}_{3} & 0 \\ - {z}_{2}^{*} & {z}_{1}^{*} & 0 & - {z}_{3} \\ - {z}_{3}^{*} & 0 & {z}_{1}^{*} & {z}_{2} \\ 0 & - {z}_{2}^{*} & - {z}_{2}^{*} & {z}_{1}\end{matrix} ] \qquad [ Equation 5 ]$$

The code matrix C cannot be represented in accordance with a complex linear superposition method used for a conventional orthogonal STBC system. Therefore, in the embodiment of the present invention, the code matrix C is matched to a channel matrix H in accordance with the real linear superposition method using the lattice representation method. As a result, the lattice representation is obtained as the following Equation 6.

$$\tilde{r} = \tilde{H} \tilde{z} + \tilde{n} \\ \begin{matrix}\tilde{r} = [ \begin{matrix}{r}^{R} \\ {r}^{I}\end{matrix} ] , & \tilde{z} = [ \begin{matrix}{z}^{R} \\ {z}^{I}\end{matrix} ] , & \tilde{n} = [ \begin{matrix}{n}^{R} \\ {n}^{I}\end{matrix} ] ,\end{matrix} \\ \begin{matrix}r = [ \begin{matrix}{r}_{1} \\ {r}_{2} \\ ⋮ \\ {r}_{L}\end{matrix} ] , & z = [ \begin{matrix}{z}_{1} \\ {z}_{2} \\ ⋮ \\ {z}_{K}\end{matrix} ] , & n = [ \begin{matrix}{n}_{1} \\ {n}_{2} \\ ⋮ \\ {n}_{L}\end{matrix} ]\end{matrix} \qquad [ Equation 6 ]$$

Here, r_{I} denotes a vector signal corresponding to signals received from all the transmit antennas during a time interval I, and n_{I} denotes a noise vector signals corresponding to noises of the signals received from all the transmit antennas during a time interval I. Here, \tilde{r}, ñ are vector signals having real and imaginary parts and have twice sizes of the respective original vectors.

For example, if signals are transmitted from 4 transmit antennas during 4 block time intervals, the signal vector \tilde{r} has a size of 4×4×2 times the size of the original signal vector. Using Equation 6, the real channel response matrix \tilde{H} of the channel matrix H matched to the code matrix C of Equation 5 can be represented by the following Equation 7.

$$\tilde{H} = [ \begin{matrix}{h}_{1 , 1}^{R} & {h}_{2 , 1}^{R} & {h}_{3 , 1}^{R} & - {h}_{1 , 1}^{I} & - {h}_{2 , 1}^{I} & - {h}_{3 , 1}^{I} \\ {h}_{2 , 2}^{R} & - {h}_{1 , 2}^{R} & - {h}_{4 , 2}^{R} & {h}_{2 , 2}^{I} & - {h}_{1 , 2}^{I} & {h}_{4 , 2}^{I} \\ {h}_{3 , 3}^{R} & {h}_{4 , 3}^{R} & - {h}_{1 , 3}^{R} & {h}_{3 , 3}^{I} & - {h}_{4 , 3}^{I} & - {h}_{1 , 3}^{I} \\ {h}_{4 , 4}^{R} & - {h}_{3 , 4}^{R} & {h}_{2 , 4}^{R} & - {h}_{4 , 4}^{I} & - {h}_{3 , 4}^{I} & {h}_{2 , 4}^{I} \\ {h}_{1 , 1}^{I} & {h}_{2 , 1}^{I} & {h}_{3 , 1}^{I} & {h}_{1 , 1}^{R} & {h}_{2 , 1}^{R} & {h}_{3 , 1}^{R} \\ {h}_{2 , 2}^{I} & - {h}_{1 , 2}^{I} & - {h}_{4 , 2}^{I} & - {h}_{2 , 2}^{R} & {h}_{1 , 2}^{R} & - {h}_{4 , 2}^{R} \\ {h}_{3 , 3}^{I} & {h}_{4 , 3}^{I} & - {h}_{1 , 3}^{I} & - {h}_{3 , 3}^{R} & {h}_{4 , 3}^{R} & {h}_{1 , 3}^{R} \\ {h}_{4 , 4}^{I} & - {h}_{3 , 4}^{I} & {h}_{2 , 4}^{I} & {h}_{4 , 4}^{R} & {h}_{3 , 4}^{R} & - {h}_{2 , 4}^{R}\end{matrix} ] \qquad [ Equation 7 ]$$

The above real channel response matrix \tilde{H} can be represented by the following Equation 8 as a general express.

$$\tilde{H} = [ \begin{matrix}{H}_{1}^{R} & - {H}_{2}^{I} \\ {H}_{1}^{I} & {H}_{2}^{R}\end{matrix} ] \qquad [ Equation 8 ]$$

Put h_{mn,I} is a channel coefficient for a channel from an n-th transmit antenna to an m-th receive antenna during an I-th block time interval. The channel coefficient h_{mn,I} has a Rayleigh variation probability variable. The variation value is 0.5 per complex dimension. If a channel response vector for the channels from all the transmit antennas to the n-th receive antenna is represented by h_{n,I}, an I-th row block of the H₁ is determined to be c₁*h_{n,I} based on the c₁*xₖ, that is, the real part of the C_{I,n}, and an I-th row block of the H₂ is determined to be c₂*h_{n,I} based on the c₂*yₖ, that is, the imaginary part of the C_{I,n}.

Now, a minimum mean square error (MMSE) in a non quasi-static channel environment is obtained by using the real channel response matrix \tilde{H} of the channel matrix H as follows.

A mean square error (MSE) is represented by the following Equation 9. In addition, the orthogonality, “if the signal vector and the error components are orthogonal to each other, the error has a minimum value”, is used. The orthogonality is represented by the following Equation 10.
E{(z~−Wr~)^{T}(z~−Wr~)} [Equation 9]
E[(\tilde{z}−W\tilde{r})\tilde{r}^{T}]=0 [Equation 10]

Then, an equalizer matrix W which minimizes the MSE, Equations 9, and is from the orthogonality principle, the MSE is minimized if and only if an error signal is orthogonal to the signal vector, Equations 10 is represented by the following Equation 11.

$$\begin{matrix}W = {( {\tilde{H}}^{T} \tilde{H} + \frac{{σ}_{n}^{2}}{{\overline{ɛ}}_{z}} I )}^{- 1} {\tilde{H}}^{T} \\ = {( {\tilde{H}}^{T} \tilde{H} + \frac{1}{SNR} I )}^{- 1} {\tilde{H}}^{T}\end{matrix} \qquad [ Equation 11 ]$$

Equation 11 represent the MMSE filter. Here, the SNR, σₙ², and \overline{ε}_{z} denote a signal-to-noise ratio (SNR), a variation of a noise, and a variation of a signal, respectively.

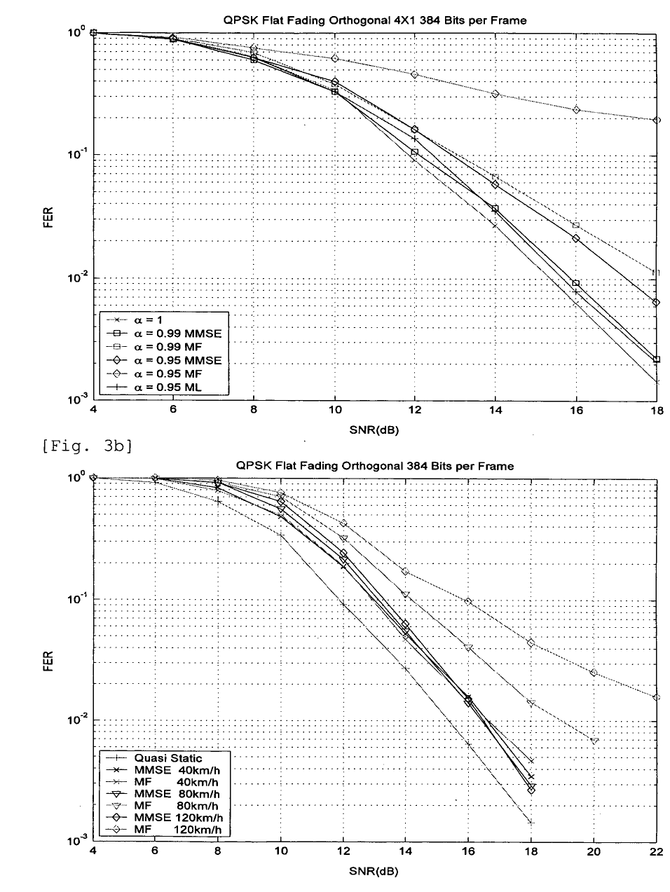

Now, the MMSE filter according to the present invention will be described with reference to FIGS. 3A and 3B. FIG. 3A is a graph showing a frame error rate (FER) of a matching filter (MF) used for a conventional STBC scheme, and FIG. 3B is a graph showing an FER of the MMSE filter used for the STBC scheme according the present invention.

Firstly, FIG. 3A shows the FER of the STBC scheme where four transmit antennas and one receive antenna in flat fading channel with various channel offset are used. In the figure, α denotes a filter variable indicating how different a current channel is from a previous channel. If the filter variable α is smaller and smaller, the correlation between the current and previous channels is getting smaller. In other words, if the filter variable a is smaller and smaller, a speed of a mobile station increases.

The figure shows the FERs of a conventional STBC scheme using the matching filter (MF) and an STBC scheme using the MMSE filter and full maximum likelihood (ML) filter according to the present invention at a filter variable α of 0.99 and 0.95. In the figure, a curve corresponding to a filter variable α of 1 shows the FER of a quasi-static channel environment of the STBC scheme.

In the STBC scheme using the MF, as the filter variable α decrease from 0.99 to 0.95, the FER steeply increases, so that the characteristic deteriorates. In addition, in a case where the FER is 10⁻², an SNR of the STBC scheme using the MF having a filter variable α of 0.99 decreases by about 3 dB (18.5−15.5 dB) in comparison to that of quasi-static channel environment of the STBC scheme (α=1). In addition, it can be understood that the characteristic of the STBC scheme using the MF having a filter variable α of 0.95 further deteriorates.

On the other hand, in the STBC using the MMSE filter, the FER is almost equal to that of the quasi-static STBC scheme (α=1), so that the characteristic does not largely deteriorate. In addition, in a case where the FER is 10⁻², an SNR of the STBC scheme using the MMSE filter having a filter variable α of 0.99 decreases by about 0.5 dB (16.0−15.5) in comparison to that of the quasi-static STBC scheme (α=1). In addition, it can be understood that the SNR of the STBC scheme using the MMSE filter having a filter variable α of 0.95 is not almost different from that of the STBC scheme using the Full ML filter because the difference is 1 dB or less.

Secondly, FIG. 3B shows the FER of the STBC scheme where four transmit antennas transmit signals and motile stations with different speeds receive the signals. The figure shows the FERs of a conventional STBC scheme using the matching filter (MF) and an STBC scheme using the MMSE filter according to the present invention at three cases of speed and Doppler frequency: 80 km/h and 430 Hz, 120 km/h and 644 Hz, and 150 km/h and 806 Hz.

As shown in FIG. 3, although the SNR of the STBC scheme using the matching filter is greatly different from that of the quasi-static STBC scheme (α=1) at the same FER, the SNR of the STBC scheme using the MMSE filter is not almost different from that of the quasi-static STBC scheme because the difference is 1 dB or less. The SNR of the STBC scheme using the MMSE filter having a filter variable α of 0.99 decreases by about 0.5 dB (16.0−15.5 dB) in comparison to that of the quasi-static STBC scheme (α=1). In addition, it can be understood that the SNR of the STBC scheme using the MMSE filter having a filter variable α of 0.95 is not almost different from that of the STBC scheme using the Full ML filter, because the difference is 1 dB or less.

Accordingly, it can be understood that, at the same filter variable, the MMSE filter according to the present invention has excellent performance in comparison to the conventional matching filer. In addition, it can be understood that, at high speed and Doppler frequency, the MMSE filter according to the present invention has excellent performance in comparison to the conventional matching filer.

The lattice presentation for the linear superposition method according to the present invention can be used for a general STBC scheme. In addition, the lattice presentation can be used for a signal-processing scheme such as equalizer scheme. In addition, the MMSE linear equalizer or filter implemented by using the lattice representation method can be used to alleviate deterioration in performance of a non quasi-static channel environment.

As shown in FIGS. 3A and 3B, in case of a non quasi-static channel environment, the performance of the STBC scheme using the MMSE equalizer according to the present invention does not deteriorate in comparison to the STBC scheme using the conventional matching filter even though the speed of the mobile station increases.

According to the present invention, by providing a STBC scheme, where a received signal is filtered by a MMSE filter using a lattice representation method where a code matrix is decomposed into real and imaginary parts, and where channel symbols are individually decoded and converted into bit information, it is possible to minimize a MSE can be minimized by using a linear superposition form applicable to the non quasi-static channel environment as well as a quasi-static channel environment.

In addition, according to the present invention, by providing an STBC scheme using a MMSE filter obtained in a real linear representation method, it is possible to recover transmitted data without loss thereof even in a case where a speed of a mobile station is high.

While the present invention has been particularly shown and described with reference to exemplary embodiments thereof, it will be understood by those of ordinary skill in the art that various changes in form and details may be made therein without departing from the spirit and scope of the present invention as defined by the following claims.

We claim:

1. A non quasi-static space time block codes (STBC) method used for a wireless communication system where information symbols represented with code matrix C, channel matrix H and noise matrix N are coded in space time coding scheme and transmitted through a plurality of transmit antennas to a receive antenna, said method comprising;
receiving one block of said information symbols by said receive antenna to provide received information symbols;
decomposing the code matrix C of said received information symbols into real and imaginary parts;
matching said code matrix C to the channel matrix H;
obtaining a real channel response matrix corresponding to said channel matrix H matched to said code matrix C to provide a received signal having said real channel response matrix;
minimizing a mean square error (MSE) of said received signal, by using a minimum mean square error (MMSE) filter;
decoding channel symbols in said real channel response matrix; and
converting said channel symbols into bit information.

2. The non quasi-static space time block codes (STBC) method according to claim 1, wherein each of said real channel response matrixes are represented by the following equation:
$$\tilde{H} = [ \begin{matrix}{H}_{1}^{R} & - {H}_{2}^{I} \\ {H}_{1}^{I} & {H}_{2}^{R}\end{matrix} ] .$$

3. The non quasi-static space time block codes (STBC) method according to claim 1, further comprising the step of:
minimizing a mean square error (MSE) of a received signal, wherein said received signal is obtained from said step of matching said code matrix C, by using a minimum mean square error (MMSE) filter to provide a minimized signal.

4. The non quasi-static space time block codes (STBC) method according to claim 1, wherein said MMSE filter is represented by the following equation:
$$W = {( {\tilde{H}}^{T} \tilde{H} + \frac{1}{SNR} I )}^{- 1} {\tilde{H}}^{T} .$$

5. The non quasi-static space time block codes (STBC) method according to claim 1, further comprising the step of:
converting said bit information into a serial signal.

6. The non quasi-static space time block codes (STBC) method according to claim 1, wherein said step of matching said code matrix C to the channel matrix H is accomplished with the real linear superposition method.

7. The non quasi-static space time block codes (STBC) method according to claim 1, wherein said step of matching said code matrix C to the channel matrix H is accomplished with the real linear superposition method using the lattice representation method.

8. The non quasi-static space time block codes (STBC) method according to claim 7, wherein said lattice representation is represented by the equation: \tilde{r}=\tilde{H}\tilde{z}+ñ.

9. The non quasi-static space time block codes (STBC) method according to claim 1, wherein said mean square error is represented by the equation:
E{(z~−Wr~)^{T}(z~−Wr~)}

10. The non quasi-static space time block codes (STBC) method according to claim 1, wherein said step of minimizing said MSE is through an equalizer matrix.

11. The non quasi-static space time block codes (STBC) method according to claim 10, wherein said MSE is orthogonal and represented by the equation:
E[(\tilde{z}−W\tilde{r})\tilde{r}^{T}=0

12. A non quasi-static space time block codes (STBC) method used for a wireless communication system where information symbols represented with code matrix C, channel matrix H and noise matrix N are coded in space time coding scheme and transmitted through a plurality of transmit antennas to a receive antenna, said method comprising;
receiving one block of said information symbols by said receive antenna to provide received information symbols;
decomposing the code matrix C of said received information symbols into real and imaginary parts;
matching said code matrix C to the channel matrix H and obtaining a real channel response matrix corresponding to said channel matrix H matched to said code matrix C, wherein each of said real channel response matrixes are represented by the following equation:
$$\tilde{H} = [ \begin{matrix}{H}_{1}^{R} & - {H}_{2}^{I} \\ {H}_{1}^{I} & {H}_{2}^{R}\end{matrix} ]$$
to provide a received signal having said real channel response matrix;
minimizing a mean square error (MSE) of said received signal, by using a minimum mean square error (MMSE) filter;
decoding channel symbols in said real channel response matrix;
converting said channel symbols into bit information.

13. The non quasi-static space time block codes (STBC) method according to claim 12, wherein said MMSE filter is represented by the following equation:
$$W = {( {\tilde{H}}^{T} \tilde{H} + \frac{1}{SNR} I )}^{- 1} {\tilde{H}}^{T} .$$

14. The non quasi-static space time block codes (STBC) method according to claim 12, further comprising the step of:
converting said bit information into a serial signal.

15. The non quasi-static space time block codes (STBC) method according to claim 12, wherein said step of matching said code matrix C to the channel matrix H is accomplished with the real linear superposition method using the lattice representation method.

16. The non quasi-static space time block codes (STBC) method according to claim 12, wherein said lattice representation is represented by the equation: \tilde{r}=\tilde{H}\tilde{z}+ñ.

17. The non quasi-static space time block codes (STBC) method according to claim 12, wherein said mean square error is represented by the equation: E{(z~−Wr~)^{T}(z~−Wr~)}

18. The non quasi-static space time block codes (STBC) method according to claim 12, further comprising the step of minimizing said MSE according to an equalizer matrix.

19. The non quasi-static space time block codes (STBC) method according to claim 12, wherein said mean square error is orthogonal and represented by the equation:
E[(\tilde{z}−W\tilde{r})\tilde{r}^{T}=0

20. A receiver used for a non quasi-static space time block codes (STBC) system using a minimum mean square error (MMSE) filter, said receiver comprising:
m receive antennas for receiving space time block code symbols transmitted from n transmit antennas of a transmitter;
a space time equalizer having the MMSE filter to decode said symbols output from said m receive antennas; and
at least one de-mapper for converting k symbols filtered by said MMSE filter into bit information.

21. The receiver according to claim 20, wherein said bit information are parallel symbols grouped into k blocks.

22. The receiver according to claim 20, further comprising:
a parallel-to-serial converter for converting said bit information from said de-mapper into a serial symbol.

23. The receiver according to claim 20, wherein said MMSE is implemented in a liner superposition form.

24. The receiver according to claim 20, wherein said MMSE is implemented in a liner superposition form using a lattice representation method.

25. The receiver according to claim 20, wherein said MMSE filter is represented by the following equation
$$W = {( {\tilde{H}}^{T} \tilde{H} + \frac{1}{SNR} I )}^{- 1} {\tilde{H}}^{T} .$$

26. The receiver according to claim 20, wherein the MMSE filter is represented by the following equation
$$W = {( {\tilde{H}}^{T} \tilde{H} + \frac{1}{SNR} I )}^{- 1} {\tilde{H}}^{T} .$$
